(19) United States
(12) Patent Application Publication
(10) Pub. No.: US 2025/0091739 A1
(43) Pub. Date: Mar. 20, 2025

(54) HIGH-ALTITUDE BALLOON PAYLOAD WITH ATTITUDE CONTROL AND PREDICTIVE SCHEDULING, FOR AEROBIOLOGICAL SAMPLING AND ENVIRONMENTAL MONITORING

(71) Applicant: Arizona Board of Regents on Behalf of Arizona State University, Scottsdale, AZ (US)

(72) Inventors: Jnaneshwar DAS, Tempe, AZ (US); Cole BRAUER, Mesa, AZ (US); Anyell MATA, Glendale, AZ (US); Elizabeth TREMBATH-REICHERT, Tempe, AZ (US); Sophia DAVIS, Ithaca, NY (US); Darwin MICK, Pittsburgh, PA (US); Thomas SHARP, Tempe, AZ (US); Desmond HANAN, Riverside, CA (US)

(21) Appl. No.: 18/886,876

(22) Filed: Sep. 16, 2024

Related U.S. Application Data
(60) Provisional application No. 63/583,238, filed on Sep. 15, 2023.

(51) Int. Cl. B64U 10/30; B64U 20/87; B64U 50/31; B64U 101/35

(52) U.S. Cl. CPC B64U 10/30; B64U 20/87; B64U 50/31; B64U 2101/35

(57) ABSTRACT

A high-altitude balloon payload with a frame, a GPS and compass module, a flight controller, a sensor probe, an orientation control system and an antenna. The frame is configured to be suspended from a high-altitude balloon. The GPS and compass module is mounted on the frame and is configured to collect location data and orientation data of the frame. The flight controller is mounted on the frame and is configured to control the orientation of the frame based on the location data and the orientation data. The orientation control system is mounted on the frame, operatively coupled to the flight controller, and configured to provide control of the orientation of the frame. The sensor probe is positioned on the frame and configured to take atmospheric measurements. The antenna is configured to establish a radio telemetry link with a ground station and wirelessly communicate the atmospheric measurements to the ground station.

### RELATED APPLICATIONS

This application claims the benefit of U.S. provisional patent application 63/583,238, filed Sep. 15, 2023, to Das et al., titled “HIGH-ALTITUDE BALLOON PAYLOAD WITH ATTITUDE CONTROL AND PREDICTIVE SCHEDULING, FOR AEROBIOLOGICAL SAMPLING AND ENVIRONMENTAL MONITORING,” the entirety of the disclosure of which is hereby incorporated by this reference.

### STATEMENT REGARDING FEDERALLY SPONSORED RESEARCH OR DEVELOPMENT

This invention was made with government support under grant no. 1521617 awarded by the National Science Foundation and under 80NSSC21K0524 awarded by the National Aeronautical & Space Administration. The government has certain rights in the invention.

### TECHNICAL FIELD

This document relates to a high-altitude balloon payload with attitude control and predictive scheduling, for aerobiological sampling and environmental monitoring.

### BACKGROUND

High-altitude balloons have been widely used for scientific research and environmental monitoring due to their ability to ascend to the upper troposphere and lower stratosphere, where they can collect valuable data in regions that are difficult to access using traditional aircraft or satellites. These balloons have proven useful in a variety of applications, including atmospheric studies, weather forecasting, and aerobiological sampling. However, many conventional high-altitude balloon payloads face limitations in terms of stability, control, and precision in data collection, particularly when it comes to environmental monitoring and aerobiological sampling, which often require precise positioning and orientation.

Aerobiological sampling at high altitudes is critical for studying airborne microorganisms, allergens, and pollutants that may travel long distances in the atmosphere and have significant implications for public health, agriculture, and climate. Accurate sampling of these particles is often dependent on the payload's ability to maintain a specific orientation or attitude relative to the wind and other environmental factors. Without proper control, the payload may experience uncontrolled tumbling or swaying, which can reduce the accuracy and efficiency of sampling devices. Furthermore, environmental monitoring sensors, such as those measuring temperature, humidity, and gas concentrations, require stable platform orientation to ensure precise data collection.

Traditional high-altitude balloon systems lack effective attitude control mechanisms, making it difficult to achieve consistent orientation of the payload during flight. In many cases, this results in limited data accuracy, higher operational costs, and reduced reliability of the collected samples. Existing methods to control payload orientation are typically passive or offer only limited control over the payload's movement, leading to incomplete or inconsistent data sets, particularly in turbulent atmospheric conditions.

### SUMMARY

Aspects of this document relate to a multilevel high-altitude balloon payload, comprising a frame configured to be suspended from a high-altitude balloon, a GPS and compass module mounted on the frame and configured to collect location data and orientation data of the frame, a flight controller mounted on the frame and communicatively coupled to the GPS and compass module, wherein the flight controller is configured to control the orientation of the frame based on the location data and orientation data collected by the GPS and compass module, an aerobiological sampling payload positioned on the frame and configured to collect and store air samples, a sensor probe positioned on the frame and configured to take atmospheric measurements of conditions surrounding the high-altitude balloon payload, wherein the conditions include humidity, temperature, wind speed and direction, and light intensity and flux, at least one reaction wheel mounted on the frame, operatively coupled to the flight controller, and configured to provide control of the orientation of the frame through rotation of the at least one reaction wheel, at least one battery mounted on the frame and configured to power the payload, an imaging system configured to collect environmental imaging data of the payload, and an antenna configured to establish a radio telemetry link between the high-altitude balloon payload and a ground station and wirelessly communicate at least one of the location data, the orientation data, the atmospheric measurements, and the environmental imaging data to the ground station.

Particular embodiments may comprise one or more of the following features. The payload may comprise one or more solar panels mounted on a side of the frame, wherein the flight controller is configured to control the orientation of the frame to orient the one or more solar panels toward the sun. The sensor probe may have an onboard microcontroller. The at least one reaction wheel may be oriented to rotate about a vertical axis and configured to stabilize a yaw angle of the frame. The imaging system may have a pitch-gimbaled multi-spectral camera and a spectrometer. The frame may be configured to swivel with respect to the high-altitude balloon over a range of at least 360 degrees.

Aspects of this document relate to a multilevel high-altitude balloon payload, comprising a frame configured to be suspended from a high-altitude balloon, a GPS and compass module mounted on the frame and configured to collect location data and orientation data of the frame, a flight controller mounted on the frame and communicatively coupled to the GPS and compass module, wherein the flight controller is configured to control the orientation of the frame based on the location data and orientation data collected by the GPS and compass module, a sensor probe positioned on the frame and configured to take atmospheric measurements, an orientation control system mounted on the frame, operatively coupled to the flight controller, and configured to provide control of the orientation of the frame, and an antenna configured to establish a radio telemetry link between the high-altitude balloon payload and a ground station and wirelessly communicate the atmospheric measurements to the ground station.

Particular embodiments may comprise one or more of the following features. The payload may comprise one or more solar panels mounted on a side of the frame, wherein the flight controller is configured to control the orientation of the frame to orient the one or more solar panels toward the sun. The sensor probe may have an onboard microcontroller. The frame may be configured to swivel with respect to the high-altitude balloon over a range of at least 360 degrees. The payload may comprise an aerobiological sampling payload positioned on the frame and configured to collect and store air samples. The orientation control system may comprise at least one reaction wheel and the orientation control system may be configured to provide control of the orientation of the frame through rotation of the at least one reaction wheel. The at least one reaction wheel may be oriented to rotate about a vertical axis and configured to stabilize a yaw angle of the frame. The payload may comprise an imaging system configured to collect environmental imaging data of the payload. The imaging system may have a pitch-gimbaled multi-spectral camera and a spectrometer.

Aspects of this document relate to a method of collecting data at a high altitude, the method comprising suspending a multilevel high-altitude balloon payload from a high-altitude balloon, collecting location data and orientation data regarding the high-altitude balloon payload, positioning the high-altitude balloon payload in a desired orientation based on the location data and orientation data, collecting and storing air samples in the high-altitude balloon payload, taking atmospheric measurements with the high-altitude balloon payload, gathering environmental imaging data with the high-altitude balloon payload, establishing a radio telemetry link between the high-altitude balloon payload and a ground station, and wirelessly communicating the location data, the orientation data, the atmospheric measurements, and the environmental imaging data to the ground station.

Particular embodiments may comprise one or more of the following features. Positioning the high-altitude balloon payload in the desired orientation may comprise orienting a solar panel on the high-altitude balloon payload toward the sun. The method may further comprise recharging a battery on the high-altitude balloon payload with energy generated by the solar panel. Positioning the high-altitude balloon payload in the desired orientation may comprise determining a desired direction of rotation for the high-altitude balloon payload and rotating a reaction wheel mounted on the high-altitude balloon payload in a direction opposite the desired direction of rotation. The high-altitude balloon payload may be configured to swivel with respect to the high-altitude balloon over a range of at least 360 degrees.

The foregoing and other aspects, features, and advantages will be apparent from the DESCRIPTION and DRAWINGS, and from the CLAIMS if any are included.

### BRIEF DESCRIPTION OF THE DRAWINGS

Implementations will hereinafter be described in conjunction with the appended and/or included DRAWINGS, where like designations denote like elements, and:

FIG. 1 is a perspective view of a high-altitude balloon payload according to some embodiments;

FIG. 2 is a side view of a high-altitude balloon payload according to some embodiments;

FIG. 3 is a perspective view of a high-altitude balloon payload according to some embodiments;

FIG. 4 is perspective view of a high-altitude balloon payload according to some embodiments; and

FIG. 5 is a side view of multiple high-altitude balloon payloads suspended from the same high-altitude balloon according to some embodiments.

### DETAILED DESCRIPTION

Detailed aspects and applications of the disclosure are described below in the following drawings and detailed description of the technology. Unless specifically noted, it is intended that the words and phrases in the specification and the claims be given their plain, ordinary, and accustomed meaning to those of ordinary skill in the applicable arts.

In the following description, and for the purposes of explanation, numerous specific details are set forth in order to provide a thorough understanding of the various aspects of the disclosure. It will be understood, however, by those skilled in the relevant arts, that embodiments of the technology disclosed herein may be practiced without these specific details. It should be noted that there are many different and alternative configurations, devices and technologies to which the disclosed technologies may be applied. The full scope of the technology disclosed herein is not limited to the examples that are described below.

The singular forms “a,” “an,” and “the” include plural referents unless the context clearly dictates otherwise. Thus, for example, reference to “a step” includes reference to one or more of such steps.

The word “exemplary,” “example,” or various forms thereof are used herein to mean serving as an example, instance, or illustration. Any aspect or design described herein as “exemplary” or as an “example” is not necessarily to be construed as preferred or advantageous over other aspects or designs. Furthermore, examples are provided solely for purposes of clarity and understanding and are not meant to limit or restrict the disclosed subject matter or relevant portions of this disclosure in any manner. It is to be appreciated that a myriad of additional or alternate examples of varying scope could have been presented, but have been omitted for purposes of brevity.

When a range of values is expressed, another embodiment includes from the one particular value and/or to the other particular value. Similarly, when values are expressed as approximations, by use of the antecedent “about,” it will be understood that the particular value forms another embodiment. All ranges are inclusive and combinable.

Throughout the description and claims of this specification, the words “comprise” and “contain” and variations of the words, for example “comprising” and “comprises”, mean “including but not limited to”, and are not intended to (and do not) exclude other components.

As required, detailed embodiments of the present disclosure are included herein. It is to be understood that the disclosed embodiments are merely exemplary of the invention that may be embodied in various forms. Therefore, specific structural and functional details disclosed herein are not to be interpreted as limits, but merely as a basis for teaching one skilled in the art to employ the present invention. The specific examples below will enable the disclosure to be better understood. However, they are given merely by way of guidance and do not imply any limitation.

The present disclosure may be understood more readily by reference to the following detailed description taken in connection with the accompanying figures and examples, which form a part of this disclosure. It is to be understood that this disclosure is not limited to the specific materials, devices, methods, applications, conditions, or parameters described and/or shown herein, and that the terminology used herein is for the purpose of describing particular embodiments by way of example only and is not intended to be limiting of the claimed inventions. The term “plurality”, as used herein, means more than one. When a range of values is expressed, another embodiment includes from the one particular value and/or to the other particular value. Similarly, when values are expressed as approximations, by use of the antecedent “about,” it will be understood that the particular value forms another embodiment. All ranges are inclusive and combinable.

More specifically, this disclosure, its aspects and embodiments, are not limited to the specific material types, components, methods, or other examples disclosed herein. Many additional material types, components, methods, and procedures known in the art are contemplated for use with particular implementations from this disclosure. Accordingly, for example, although particular implementations are disclosed, such implementations and implementing components may comprise any components, models, types, materials, versions, quantities, and/or the like as is known in the art for such systems and implementing components, consistent with the intended operation.

The present disclosure is related to a high-altitude balloon payload 100 configured to be carried by a high-altitude balloon 10. The high-altitude balloon payload 100 is equipped with attitude control. The high-altitude balloon payload 100 is thus configured to stabilize and orient the high-altitude balloon payload 100 to optimize the collection of aerobiological samples and environmental data. This helps to ensure that sampling devices and sensors are correctly positioned and aligned during the flight, improving the quality and consistency of the collected data and enabling more reliable research outcomes in atmospheric and environmental sciences. Thus, the present disclosure addresses the present challenges associated with high-altitude balloons by providing a high-altitude balloon payload 100 with an integrated attitude control system designed specifically for precise aerobiological sampling and environmental monitoring at high altitudes, as described in more detail below.

The high-altitude balloon payload 100 is designed to be lightweight, have a small size, and consume less power. Thus, the high-altitude balloon payload 100 may have a low SWaP (Size, Weight, and Power). For example, the high-altitude balloon payload 100 may be designed to be less than 1.5 kilograms. Additionally, the high-altitude balloon payload 100 is designed to have a low total cost (<$300). The high-altitude balloon payload 100 includes drone flight control technology and custom environmental sensing hardware.

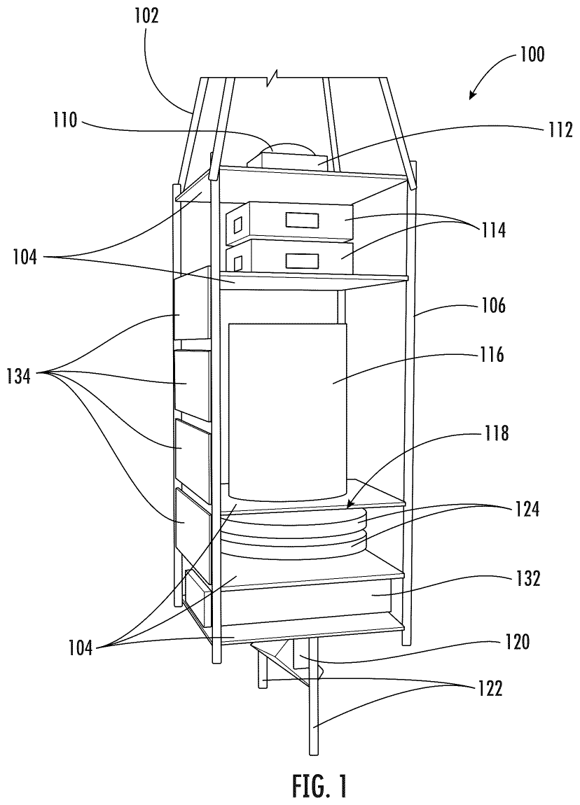

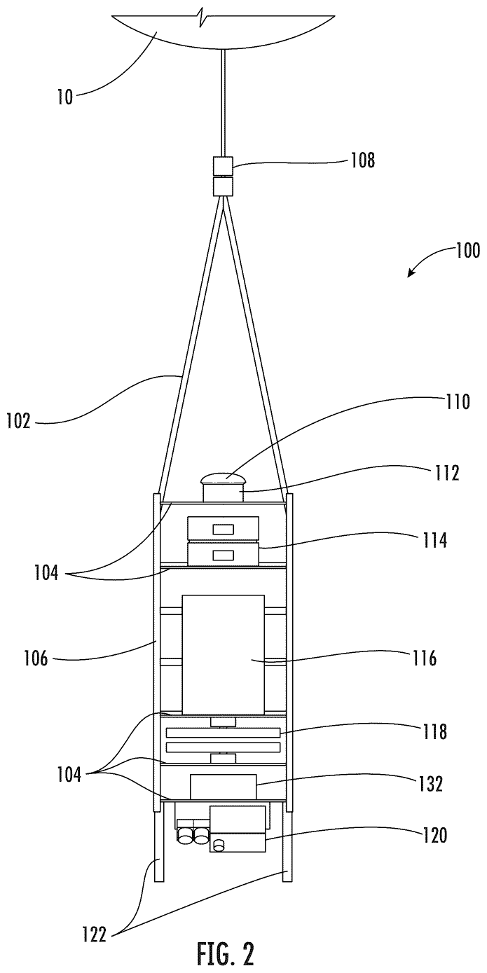

In some embodiments, the high-altitude balloon payload 100 comprises a frame 102 that is multilevel, and thus is formed into a plurality of levels 104. The frame 102 provides structure to the high-altitude balloon payload 100 for the various components of the high-altitude balloon payload 100. The frame 102 may also comprise spacers 106 to separate the plurality of levels 104 of the frame 102. The spacers 106 may be formed of aluminum to limit the total weight of the frame 102. Other materials that would provide the necessary structure while limiting the weight of the frame 102 may be implemented, as will be apparent to one of skill in the art. In some embodiments, the spacers 106 are load-bearing. As shown in the embodiments illustrated in FIGS. 1-5, the frame 102 may be configured to support a variety of instruments and components on the plurality of levels 104 of the frame 102. In some embodiments, the plurality of levels 104 comprises six levels. In some embodiments, the plurality of levels 104 comprises more or fewer levels.

The frame 102 is configured to be suspended from a high-altitude balloon 10. In some embodiments, the frame 102 is coupled to the high-altitude balloon 10 through a swivel 108. The swivel 108 is configured to allow the frame 102 to rotate with respect to the high-altitude balloon 10. Thus, in some embodiments, the frame 102 is configured to swivel with respect to the high-altitude balloon 10 over a range of at least 360 degrees. In some embodiments, the frame 102 is completely free to rotate with respect to the high-altitude balloon 10 such that the frame 102 has an infinite range in either direction. While this may seem contrary to the goal of stabilizing the high-altitude balloon payload 100, by allowing the high-altitude balloon payload 100 to swivel with respect to the high-altitude balloon 10, the orientation of the high-altitude balloon payload 100 is isolated from the orientation of the high-altitude balloon 10, allowing the high-altitude balloon payload 100 to function independently from the high-altitude balloon 10.

The high-altitude balloon payload 100 may also comprise a GPS and compass module 110, a flight controller 112, an sampling payload 114, a sensor probe 116, an orientation control system 118, an imaging system 120, and an antenna 122. Each of these components may be mounted on the frame 102. In some embodiments, each of the plurality of levels 104 is configured to support a different one of these components.

The GPS and compass module 110 is configured to collect location and orientation data of the frame 102. This data may be useful for each of the other components of the high-altitude balloon payload 100 because the location and orientation data can be used to determine where the high-altitude balloon payload 100 is located at the time of a particular measurement, as well as where it is headed. In particular, the GPS and compass module 110 may be useful to the flight controller 112 in reaching the desired orientation for the high-altitude balloon payload 100 by providing data regarding the current orientation of the high-altitude balloon payload 100.

The flight controller 112 is communicatively coupled to the GPS and compass module 110 and, as mentioned above, is configured to control the orientation of the frame 102 based on the location and orientation data collected by the GPS and compass module 110. The flight controller 112 may be a Pixhawk flight controller running the PX4 flight stack. The flight controller 112 is configured to perform computations relevant to the guidance, navigation, and control of the high-altitude balloon payload 100.

The sampling payload 114 is configured to collect and store air samples with the goal of capturing aerobiological samples. In some embodiments, the sampling payload 114 collects air samples and stores them in filtrates. The sampling payload 114 may be triggered by onboard computations for adaptive sampling. Thus, the high-altitude balloon payload 100 is configured to recognize circumstances where more frequent or less frequent sampling is merited and adapt the sampling schedule based on these computations and based on measurements taken by other systems of the high-altitude balloon payload 100.

The sensor probe 116 is configured to take atmospheric measurements of conditions surrounding the high-altitude balloon payload 100. The conditions may include humidity, temperature, wind speed, wind direction, light intensity, and light flux. Similar to other systems of the high-altitude balloon payload 100, the sensor probe 116 may be capable of decision-making, and may use an onboard Arduino Feather or other microcontroller. The sensor probe 116 may be an EarthPod sensor probe. As noted above, many of these measurements can be negatively affected by undesired movement and orientation of the high-altitude balloon payload 100. For this reason, the high-altitude balloon payload 100 is configured to provide attitude control, as discussed in more detail below. By improving the attitude control of the high-altitude balloon payload 100, the measurements taken by the sensor probe 116 are more accurate and reliable, making models, estimates, projections, and predictions based on the these measurements also more accurate and reliable.

The orientation control system 118, also called the yaw stabilization system, is configured to provide control of the orientation of the frame 102 to the high-altitude balloon payload 100, and specifically to the flight controller 112. The orientation control system 118 may comprise a reaction wheel 124, also known as a momentum wheel, that is configured to rotate to control the orientation of the frame 102. The reaction wheel 124 operates based on the principle of conservation of angular momentum. The reaction wheel 124 is configured to spin around a specific axis. In some embodiments, the reaction wheel 124 is oriented to rotate about a vertical axis and is configured to stabilize a yaw angle of the frame 102. In some embodiments, the axis of the reaction wheel 124 is vertical and is aligned to extend up through the frame 102 and the high-altitude balloon 10. When the reaction wheel 124 spins in one direction, the high-altitude balloon payload 100 rotates in the opposite direction. By precisely controlling the speed and direction of the rotation of the reaction wheel 124, the high-altitude balloon payload 100 can be placed in a desired orientation.

In addition to rotating the high-altitude balloon payload 100 to a specific orientation, the reaction wheel 124 can also help prevent unwanted rotation of the high-altitude balloon payload 100. If the high-altitude balloon payload 100 begins to rotate unintentionally, such as due to an external force, the orientation control system 118 may be configured to detect the motion and rotate the reaction wheel 124 in the opposite direction to counteract it, thus stabilizing the high-altitude balloon payload 100. In essence, the reaction wheel 124 transfers angular momentum between itself and the high-altitude balloon payload 100 to achieve and maintain the desired orientation.

In some embodiments, the orientation control system 118 comprises one or more reaction wheels 124, each configured to spin around a specific axis. In some embodiments, the axis of the reaction wheel 124 is aligned to extend up through the frame 102 and the high-altitude balloon 10, as noted above. However, in some embodiments, in particular those with multiple reaction wheels 124, the axes may not be aligned with the frame 102 and the high-altitude balloon 10, instead being oriented in different directions. In some embodiments, the reaction wheels 124 are oriented to provide a counter against swaying of the high-altitude balloon payload 100 with respect to the high-altitude balloon 10.

The orientation control system 118 may be operatively coupled to the flight controller 112 so that the flight controller 112 can control the orientation of the frame 102 through control of the orientation control system 118. The orientation control system 118 may include more than one reaction wheel 124 to provide for more specific control and stabilization, as noted above. The reaction wheels 124 may be configured to rotate in the same direction or in opposite directions as needed. Thus, the orientation control system 118 both controls the orientation of the high-altitude balloon payload 100 and stabilizes the high-altitude balloon payload 100 by preventing unwanted rotation.

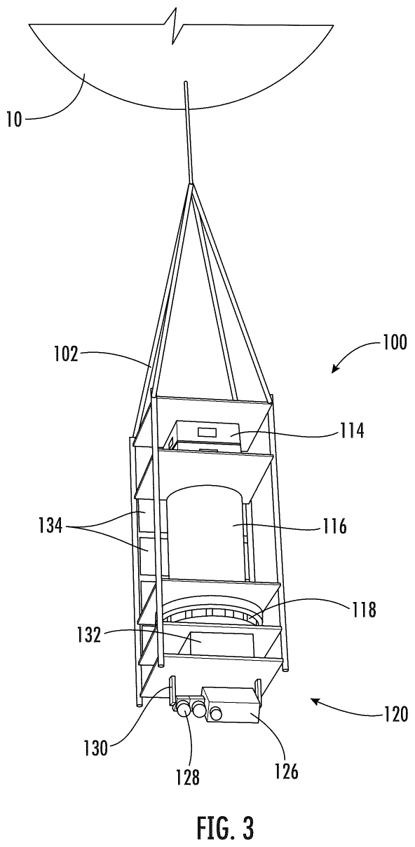

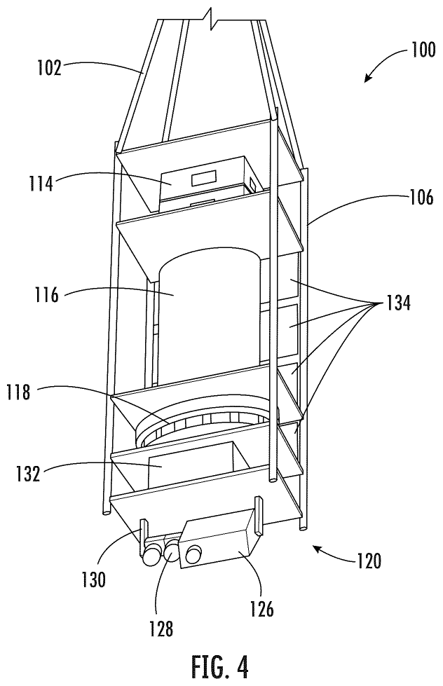

The imaging system 120 is configured to collect and/or gather environmental imaging data of the high-altitude balloon payload 100. In other words, the imaging system 120 may take pictures and collect data regarding the visual environment of the high-altitude balloon payload 100. The imaging system 120 may be equipped with Intel Atom or ARM computer to carry out image processing tasks. The imaging system 120 may have a multi-spectral camera 126 and/or a spectrometer 128 with onboard computational abilities, as shown in FIGS. 3 and 4. The imaging system 120 may be pitch-gimbaled through a gimbal system 130. Thus, the imaging system 120 may be oriented in a desired direction using a combination of the orientation control system 118 to rotate the frame 102 and the gimbal system 130 to control the pitch of the imaging system 120. Both the orientation control system 118 and the gimbal system 130 may be controlled by the flight controller 112.

The antenna 122 is configured to establish a radio telemetry link and wirelessly communicate data collected by the high-altitude balloon payload 100. The data may be communicated to a ground station or any remote location. In many embodiments, the high-altitude balloon payload 100 is configured to perform most necessary computing onboard the high-altitude balloon payload 100, and therefore, the antenna 122 is generally used to communicate data, but not send and receive information relevant to the orientation of the high-altitude balloon payload 100 and the performance of the different components such as the flight controller 112, the sampling payload 114, the sensor probe 116, the orientation control system 118, and the imaging system 120. All decision-making may happen onboard the high-altitude balloon payload 100, with computations split between the flight controller 112 for guidance, navigation, and control, the sensor probe for atmospheric and aerobiological sampling, and the imaging system 120 for image processing tasks.

The high-altitude balloon payload 100 may also comprise a battery 132. The battery 132 is configured to power the high-altitude balloon payload 100. The battery 132 may be a lithium-polymer battery and may comprise multiple batteries. Other types of batteries may also be implemented. In some embodiments, the high-altitude balloon payload 100 also comprises one or more solar panels 134 mounted on a side of the frame 102. The solar panels 134 are configured to collect solar energy and store it in the battery 132. In other words, the solar panels 134 are configured to recharge the battery 132 with energy generated by the solar panels 134. The flight controller 112 may be configured to control the orientation of the frame 102 to orient the solar panels 134 toward the sun. Thus, the battery 132 may be recharged with the solar panels 134 that are actively oriented by the orientation control system 118. In some embodiments, the solar panels 134 may be included on more than one side of the frame or tower. The flight controller 112 in conjunction with the orientation control system 118 may be configured to maintain the solar panels 134 in a position oriented toward the sun. Yaw stabilization and orientation control may also enable imaging of the sun with a top mounted camera on the frame 102 or tracking features such as solar eclipse shadows.

Each of the components of the high-altitude balloon payload 100 may be configured and programmed to perform its own computations and make decisions, and then communicate the output data through the antenna 122 as needed. For example, the sensor probe 116 may have an onboard microcontroller and therefore be able to determine at which points to measure and record different atmospheric measurements. The sensor probe 116 may work in concert with the GPS and compass module 110 and the flight controller 112 to record the location of these measurements and determine the next position and time for measurements to be taken and to ensure the high-altitude balloon payload 100 is in the proper orientation for these measurements. This may all occur onboard the high-altitude balloon payload 100. Then, the antenna 122 may be used to communicate these measurements to a remote location as needed. The other components may be similarly equipped. As another example, the sampling payload 114 may be configured to determine on its own when to take air samples without input from a remote server or third party. Similarly, the flight controller 112 is configured to use the orientation control system 118 to orient the high-altitude balloon payload 100 as needed for various purposes, such as for air sampling, atmospheric measurements, facing the solar panels 134 towards the sun, or collecting images, without requiring input from a remote source.

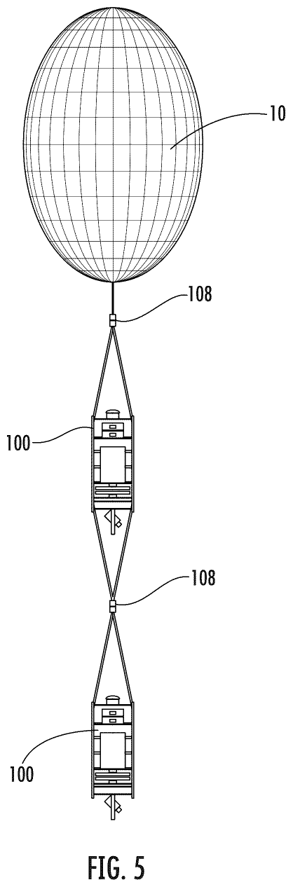

As shown in FIG. 5, multiple high-altitude balloon payloads 100 may be suspended from the same high-altitude balloon 10. Each high-altitude balloon payload 100 may act independently and therefore be oriented in different directions, perform different tasks, and take different measurements as needed.

In a particular embodiment, the components of the high-altitude balloon payload 100 are arranged with the GPS and compass module 110 on the top (6^{th}) level, along with the flight controller 112. The sampling payload 114 may be on the 5^{th} level and the sensor probe 116 for atmospheric measurements may be on the 4^{th} level. The 3^{rd} level may house the orientation control system 118 including the reaction wheels 124, the 2^{nd} level may have the battery 132, and the bottom (1^{st}) level may have the imaging system 120 and the antenna 122. Other configurations and/or arrangements may also be implemented.

A person of skill in the art will also understand that the present disclosure may also be relevant in creating a ground-based sensor probe in a sensor network format, especially where long term autonomy and attitude stabilization are desired.

The present disclosure is also related to a method of collecting data at a high altitude. The method may comprise suspending the high-altitude balloon payload 100 from a high-altitude balloon 10, collecting location data and orientation data regarding the high-altitude balloon payload 100, positioning the high-altitude balloon payload 100 in a desired orientation based on the location data and orientation data, collecting and storing air samples in the high-altitude balloon payload 100, taking atmospheric measurements with the high-altitude balloon payload 100, gathering environmental imaging data with the high-altitude balloon payload 100, establishing a radio telemetry link between the high-altitude balloon payload 100 and a ground station, and wirelessly communicating the location data, the orientation data, the atmospheric measurements, and the environmental imaging data to the ground station. As noted above, positioning the high-altitude balloon payload 100 in the desired orientation may comprise orienting the solar panels 134 on the high-altitude balloon payload 100 toward the sun. The method may also comprise recharging a battery 132 on the high-altitude balloon payload 100 with energy generated by the solar panels 134. Also as noted above, positioning the high-altitude balloon payload 100 in the desired orientation may comprise determining a desired direction of rotation for the high-altitude balloon payload 100 and rotating the reaction wheel 124 mounted on the high-altitude balloon payload 100 in a direction opposite the desired direction of rotation.

The present disclosure provides several distinct advantages over traditional high-altitude balloon systems. By incorporating an active attitude control mechanism (the orientation control system 118), the high-altitude balloon payload 100 can maintain precise orientation and stability throughout the flight, ensuring optimal alignment of sampling devices and environmental sensors. This results in more accurate and reliable data collection, particularly for sensitive applications such as aerobiological sampling, where precision is critical for capturing airborne microorganisms and particulates. The improved control of the high-altitude balloon payload 100 also enhances the efficiency of environmental monitoring, providing consistent measurements of atmospheric conditions like temperature, humidity, and gas concentrations. Additionally, the high-altitude balloon payload 100 reduces the risk of data degradation caused by uncontrolled payload movements in turbulent conditions, making it more robust and adaptable for extended scientific missions. These extended scientific missions are also supported by the battery 132 and the solar panels 134 which provide power the components of the high-altitude balloon payload 100. Overall, the high-altitude balloon payload 100 significantly improves the quality of high-altitude research while reducing operational costs and complexities associated with payload instability.

Many additional implementations are possible. Further implementations are within the CLAIMS.

It will be understood that implementations of the high-altitude balloon payload include but are not limited to the specific components disclosed herein, as virtually any components consistent with the intended operation of various high-altitude balloon payloads may be utilized. Accordingly, for example, it should be understood that, while the drawings and accompanying text show and describe particular high-altitude balloon payload implementations, any such implementation may comprise any shape, size, style, type, model, version, class, grade, measurement, concentration, material, weight, quantity, and/or the like consistent with the intended operation of high-altitude balloon payloads.

The concepts disclosed herein are not limited to the specific high-altitude balloon payload shown herein. For example, it is specifically contemplated that the components included in particular high-altitude balloon payloads may be formed of any of many different types of materials or combinations that can readily be formed into shaped objects and that are consistent with the intended operation of the high-altitude balloon payload. For example, the components may be formed of: rubbers (synthetic and/or natural) and/or other like materials; glasses (such as fiberglass), carbon-fiber, aramid-fiber, any combination therefore, and/or other like materials; elastomers and/or other like materials; polymers such as thermoplastics (such as ABS, fluoropolymers, polyacetal, polyamide, polycarbonate, polyethylene, polysulfone, and/or the like, thermosets (such as epoxy, phenolic resin, polyimide, polyurethane, and/or the like), and/or other like materials; plastics and/or other like materials; composites and/or other like materials; metals, such as zinc, magnesium, titanium, copper, iron, steel, carbon steel, alloy steel, tool steel, stainless steel, spring steel, aluminum, and/or other like materials; and/or any combination of the foregoing.

Furthermore, high-altitude balloon payloads may be manufactured separately and then assembled together, or any or all of the components may be manufactured simultaneously and integrally joined with one another. Manufacture of these components separately or simultaneously, as understood by those of ordinary skill in the art, may involve 3-D printing, extrusion, pultrusion, vacuum forming, injection molding, blow molding, resin transfer molding, casting, forging, cold rolling, milling, drilling, reaming, turning, grinding, stamping, cutting, bending, welding, soldering, hardening, riveting, punching, plating, and/or the like. If any of the components are manufactured separately, they may then be coupled or removably coupled with one another in any manner, such as with adhesive, a weld, a fastener, any combination thereof, and/or the like for example, depending on, among other considerations, the particular material(s) forming the components.

In places where the description above refers to particular high-altitude balloon payload implementations, it should be readily apparent that a number of modifications may be made without departing from the spirit thereof and that these implementations may be applied to other implementations disclosed or undisclosed. The presently disclosed high-altitude balloon payloads are, therefore, to be considered in all respects as illustrative and not restrictive.

### REFERENCES CITED AND INCORPORATED BY REFERENCE

1. WMO (2016). Guide to Instruments and Methods of Observation. World Meteorological Organization, WMO-No. 8.
2. Sargent, M., et al. (2018). Advances in weather prediction technology: Radiosondes. Weather, 73 (6), 186-191.
3. Bauer, P., et al. (2015). The quiet revolution of numerical weather prediction. Nature, 525 (7567), 47-55.
4. Lorenz, T., and Willemsen, P. (2020). Assimilation of high-resolution radiosonde data in the ICON model: Impact on weather forecasts. Weather and Forecasting, 35 (1), 381-395.
5. Ferrare, R. A., et al. (2016). Evaluation of Daytime Measurements of Aerosols and Water Vapor made by an Operational Raman Lidar over the Southern Great Plains. Journal of Geophysical Research: Atmospheres, 121 (3), 1298-1318.
6. Smith, D. J., et al. (2017). High-Altitude Aerosol Sampling: Using Balloons to Investigate Aerosol-Cloud-Climate Interactions. Eos, 98.
7. Bryant, N., et al. (2020). Vertical Stratification of Microbes in the High-Altitude Atmosphere. Frontiers in Environmental Science, 8, 575762.
8. DeLeon-Rodriguez, N., et al. (2021). Microbiome of the upper troposphere and lower stratosphere: taxa variability and potential impacts on clouds and climate. Scientific Reports, 11 (1), 5460.
9. Kallmeyer, J. (2018). Aerobiology: A frontier in microbial ecology. FEMS Microbiology Ecology, 94 (6), fiy077.

We claim:

1. A multilevel high-altitude balloon payload, comprising:
a frame configured to be suspended from a high-altitude balloon;
a GPS and compass module mounted on the frame and configured to collect location data and orientation data of the frame;
a flight controller mounted on the frame and communicatively coupled to the GPS and compass module, wherein the flight controller is configured to control the orientation of the frame based on the location data and orientation data collected by the GPS and compass module;
an aerobiological sampling payload positioned on the frame and configured to collect and store air samples;
a sensor probe positioned on the frame and configured to take atmospheric measurements of conditions surrounding the high-altitude balloon payload, wherein the conditions include humidity, temperature, wind speed and direction, and light intensity and flux;
at least one reaction wheel mounted on the frame, operatively coupled to the flight controller, and configured to provide control of the orientation of the frame through rotation of the at least one reaction wheel;
at least one battery mounted on the frame and configured to power the payload;
an imaging system configured to collect environmental imaging data of the payload; and
an antenna configured to establish a radio telemetry link between the high-altitude balloon payload and a ground station and wirelessly communicate at least one of the location data, the orientation data, the atmospheric measurements, and the environmental imaging data to the ground station.

2. The payload of claim 1, further comprising one or more solar panels mounted on a side of the frame, wherein the flight controller is configured to control the orientation of the frame to orient the one or more solar panels toward the sun.

3. The payload of claim 1, wherein the sensor probe has an onboard microcontroller.

4. The payload of claim 1, wherein the at least one reaction wheel is oriented to rotate about a vertical axis and configured to stabilize a yaw angle of the frame.

5. The payload of claim 1, the imaging system having a pitch-gimbaled multi-spectral camera and a spectrometer.

6. The payload of claim 1, wherein the frame is configured to swivel with respect to the high-altitude balloon over a range of at least 360 degrees.

7. A multilevel high-altitude balloon payload, comprising:
a frame configured to be suspended from a high-altitude balloon;
a GPS and compass module mounted on the frame and configured to collect location data and orientation data of the frame;
a flight controller mounted on the frame and communicatively coupled to the GPS and compass module, wherein the flight controller is configured to control the orientation of the frame based on the location data and orientation data collected by the GPS and compass module;
a sensor probe positioned on the frame and configured to take atmospheric measurements;
an orientation control system mounted on the frame, operatively coupled to the flight controller, and configured to provide control of the orientation of the frame; and
an antenna configured to establish a radio telemetry link between the high-altitude balloon payload and a ground station and wirelessly communicate the atmospheric measurements to the ground station.

8. The payload of claim 7, further comprising one or more solar panels mounted on a side of the frame, wherein the flight controller is configured to control the orientation of the frame to orient the one or more solar panels toward the sun.

9. The payload of claim 7, wherein the sensor probe has an onboard microcontroller.

10. The payload of claim 7, wherein the frame is configured to swivel with respect to the high-altitude balloon over a range of at least 360 degrees.

11. The payload of claim 7, further comprising an aerobiological sampling payload positioned on the frame and configured to collect and store air samples.

12. The payload of claim 7, wherein the orientation control system comprises at least one reaction wheel and wherein the orientation control system is configured to provide control of the orientation of the frame through rotation of the at least one reaction wheel.

13. The payload of claim 12, wherein the at least one reaction wheel is oriented to rotate about a vertical axis and configured to stabilize a yaw angle of the frame.

14. The payload of claim 7, further comprising an imaging system configured to collect environmental imaging data of the payload.

15. The payload of claim 14, the imaging system having a pitch-gimbaled multi-spectral camera and a spectrometer.

16. A method of collecting data at a high altitude, the method comprising:
suspending a multilevel high-altitude balloon payload from a high-altitude balloon;
collecting location data and orientation data regarding the high-altitude balloon payload;
positioning the high-altitude balloon payload in a desired orientation based on the location data and orientation data;
collecting and storing air samples in the high-altitude balloon payload;
taking atmospheric measurements with the high-altitude balloon payload;
gathering environmental imaging data with the high-altitude balloon payload;
establishing a radio telemetry link between the high-altitude balloon payload and a ground station; and
wirelessly communicating the location data, the orientation data, the atmospheric measurements, and the environmental imaging data to the ground station.

17. The method of claim 16, wherein positioning the high-altitude balloon payload in the desired orientation comprises orienting a solar panel on the high-altitude balloon payload toward the sun.

18. The method of claim 17, further comprising recharging a battery on the high-altitude balloon payload with energy generated by the solar panel.

19. The method of claim 16, wherein positioning the high-altitude balloon payload in the desired orientation comprises determining a desired direction of rotation for the high-altitude balloon payload and rotating a reaction wheel mounted on the high-altitude balloon payload in a direction opposite the desired direction of rotation.

20. The method of claim 16, wherein the high-altitude balloon payload is configured to swivel with respect to the high-altitude balloon over a range of at least 360 degrees.
